(19) United States
(12) Patent Application Publication
(10) Pub. No.: US 2024/0273345 A1
(43) Pub. Date: Aug. 15, 2024

(54) AUTOMATED GENERATIVE AI MODULE FITTING AT SCALE

(71) Applicant: Jasper AI, Inc., Austin, TX (US)

(72) Inventors: Dhruva BHARADWAJ, San Francisco, CA (US); Dmitri IOUROVITSKI, Austin, TX (US); Greg LARSON, Salt Lake City, UT (US); Rex MCARTHUR, Los Angeles, CA (US); Suhail NIMJI, Charlotte, NC (US); Saad ANSARI, Chicago, IL (US)

(73) Assignee: Jasper AI, Inc., Austin, TX (US)

(21) Appl. No.: 18/168,547

(22) Filed: Feb. 13, 2023

(51) Int. Cl. G06N 3/0475; G06F 16/2457; G06N 3/045

(52) U.S. Cl. CPC G06N 3/0475; G06F 16/24573; G06N 3/045

(57) ABSTRACT

Exemplary systems and methods are provided for generating natural language responses to input queries by receiving a first input query; determining one or more of characteristics of the input query; selecting, from a plurality of response modules, one or more response modules based on the one or more characteristics of the input query and one or more metrics associated with each of the one or more response modules, wherein each response module of the plurality of response modules comprises a plurality of machine learning models for generating a response to the input query; and generating one or more responses to the first input query using the selected one or more response modules.

### FIELD

The present disclosure relates generally to systems and methods for generative artificial intelligence, and more specifically to generating responses to input queries using generative artificial intelligence response modules tailored to specific users, user segments, and use cases.

### BACKGROUND

Generative artificial intelligence (AI) systems are systems that take in user input and process the user inputs to conversational or natural language responses using a machine learning language model. The generative AI field is relatively new, and existing systems often use a single language model to generate responses to the received inputs. Existing systems and methods generally perform well with regard to semantic output quality but fail to effectively tailor generative outputs to specific domains, users, or use cases. Methods for fitting or personalizing machine learning model outputs exist in the form of recommendation engines, which have been developed to recommend content to users based on the known preferences of specific users, but existing recommendation engines are limited to a finite pool of preexisting content. In other words, existing recommendation engines do not generate new content.

### SUMMARY

Accordingly, a need has been identified for generative AI systems that can generate content while both maintaining high levels of semantic quality and fitting generated content to known user preferences and use cases. Disclosed herein are exemplary devices, apparatuses, systems, methods, and non-transitory storage media for generating responses to input queries using response modules comprising a plurality of machine learning models, prompting, and configuration files that can be tailored to users, user segments, and use cases. The response modules disclosed herein can be understood as recipes or protocols for generating a response to a user input using a plurality of machine learning models.

Response modules may comprise a foundational generative language model and one or more secondary models, wherein the secondary models may be retrieval models, adapter models, and/or prompting optimization models. The prompting optimization models may be configured to modify a user input using data from a database or application programming interface. The retrieval models may be configured to retrieve data from a memory table comprising user data and/or a streaming application programming interface (API) and feed it to the prompting optimization model. The prompting optimization model is a generative language model that receives the user input/input query and any additional data retrieved by a retrieval model and generates a modified input query. The modified input query may comprise prompting that is best suited for a particular use case or user segment.

The adapter models may be configured to tailor responses to specific use cases or user segments which the base generative language model is not configured or trained to recognize. Adapter models are machine learning models with additional parameters added to a large pretrained model to configure the model for various specific tasks. For instance, an adapter model may receive the output of the foundational model as an input and adapt the foundational model's output. The adaptation may comprise, for instance, translating the output or injecting a specific tone or style into the output. An adapter model may also adapt the output from the prompting optimization model prior to receipt by the foundational model. For instance, if a foundational model is trained to generate English language outputs based on English language inputs, an adapter model may be used to translate a Spanish language prompt generated by the prompting optimization model.

Response modules may also comprise databases of static prompting, various configuration files, and finetuned variations of the plurality of machine learning models, among various other possible components. Prompting guides a machine learning model to generate useful output. Response modules may comprise databases of prompting that can be inserted into a user input by a prompting optimization model to improve or tailor an input to a language model within a selected module. Configuration files are files that configure parameters and initial settings for various computer programs, and as used herein can be used to further tailor response modules to specific users, use cases, and so on as needed. Finetuned machine learning models are models initial trained for one machine learning task which have been retrained and thus repurposed for a new task using different training data. As such, an input query may be processed by a selected module using a combination of the response module components to generate a response to the input query that is tailored to the specific user, user segment, use case, and so on.

The response modules described herein are selected or constructed based on user inputs, user data, and metrics associated with user preferences to generate responses that will best suit known preferences of the user and the current user input. User preferences may be determined based upon data provided by the user through a user profile and/or through interactions of the respective user or other similar users with previously generated responses. Interactions with each generated response are recorded and stored as metrics associated with various module capabilities, for instance, semantic complexity, humor, and so on. As such, response modules may be tailored to specific use cases, user segments, or even specific users based, in part, on user interactions with generated responses.

An exemplary first method for generating a response to an input query is provided, the method comprising: receiving a first input query; determining one or more of characteristics of the input query; selecting, from a plurality of response modules, one or more response modules based on the one or more characteristics of the input query and one or more metrics associated with each of the one or more response modules, wherein each response module of the plurality of response modules comprises a plurality of machine learning models for generating a response to the input query; and generating one or more responses to the first input query using the selected one or more response modules.

In some examples of the first method, the one or more characteristics of the input query are associated with any one or more of a user, a user segment, or use case.

In some examples of the first method, the one or more response modules are selected based on a user segment or use case associated with the input query.

In some examples of the first method, the one or more responses to the first input query generated using the selected one or more response modules are tailored to a user segment.

In some examples of the first method, the one or more responses to the first input query generated using the selected one or more response modules are tailored to a use case.

In some examples of the first method, the plurality of machine learning models in each respective response module comprises each of a foundational language model, one or more adapter models, one or more retrieval models, and a prompting optimization model

In some examples of the first method, an adapter model of the one or more adapter models and a retrieval model of the one or more retrieval models are provided upstream of the foundational model to modify an input to the foundational model.

In some examples of the first method, an adapter model of the one or more adapter models and a retrieval model of the one or more retrieval models are provided downstream of the foundational model to modify an output from the foundational model.

In some examples of the first method, the prompting optimization model is configured to modify the first input query using static prompting and dynamic prompting to generate a response generation prompt for the foundational language model.

In some examples of the first method, one or more of the plurality of machine learning models are finetuned machine learning models.

In some examples of the first method, an adapter model of the one or more adapter models is configured to modify the response generation prompt generated by the prompting optimization model before the response generation prompt is received by the foundational model.

In some examples of the first method, an adapter model of the one or more adapter models is configured to modify an output of the foundational model, wherein the output of the foundational model is based on the response generation prompt received by the foundational model.

In some examples of the first method, the first input query is a natural language request to generate a response.

In some examples of the first method, a generated response of the one or more responses is a natural language response to the first input query.

In some examples of the first method, the one or more metrics associated with each of the one or more response modules are based on one or more interactions of one or more users with one or more previous responses generated by one or more response modules of the plurality of response modules.

In some examples, the first method further comprises displaying the one or more generated responses to one or more users; and recording one or more interactions of the one or more users with the one or more generated responses.

In some examples, the first method further comprises determining one or more preferred metrics associated with the one or more generated responses based on the one or more recorded interactions with the one or more generated responses.

In some examples of the first method, an interaction of the one or more interactions is a positive interaction or a negative interaction.

In some examples of the first method, a positive interaction increases the likelihood of the response module being selected for a respective user segment or use case

In some examples of the first method, a negative interaction decreases the likelihood of the response module being selected for a respective user segment or use case.

In some examples, the first method further comprises updating one or more response modules of the selected one or more response modules, based on the preferred metrics, by updating one or more trained machine learning models of the response modules.

In some examples, the first method further comprises receiving a second input query; determining one or more characteristics of the second input query; respectively generating, by each of the one or more updated response modules, one or more respective responses to the second input query based on the characteristics of the second input query.

In some examples, the first method further comprises selecting, based on the preferred metrics, one or more different response modules from the plurality of response modules.

In some examples, the first method further comprises receiving a second input query; determining one or more characteristics of the second input query; and constructing, based on the preferred metrics and the one or more characteristics of the second input query, one or more response modules for generating a response to the second input query.

In some examples of the first method, a response of the one or more generated responses comprises any one or more of a request for a second input query, a description of a person, a description of a product, a description of a location, and a description of an event.

In some examples of the first method, the one or more characteristics of the input query include: a user identifier and a user prompt.

In some examples of the first method, the user identifier is associated with a user profile.

In some examples of the first method, the user profile comprises user specific data specific to a user associated with the user identifier.

In some examples of the first method, the user is a human.

In some examples of the first method, the user specific data comprises any one or more of: a user age; a user sex; a user gender; a user location; a user occupation; a user industry; a user target audience; a user product; a distribution channel; one or more previous input queries input by the user; and one or more previous responses to the input queries input by the user.

In some examples of the first method, selecting, from a plurality of response modules, one or more response modules based on the one or more characteristics of the input query and one or more metrics associated with each of the one or more response modules comprises: determining a relationship between a input query characteristic and user data associated with the input query characteristic; comparing the user data associated with the input query characteristic with one or more metrics associated with each of the plurality of response modules; and selecting, based on the comparison, one or more response modules from the plurality of response modules.

In some examples of the first method, the first user data comprises any one of a target audience, a user age, a user gender, a user location, a user occupation, and a user industry.

A first exemplary system for generating a response to an input query comprises one or more processors; a memory; and one or more programs, wherein the one or more programs are stored in the memory and configured to be executed by the one or more processors, the one or more programs including instructions for: receiving a first input query; determining one or more characteristics of the input query; selecting, from a plurality of response modules, one or more response modules based on the one or more characteristics of the input query, wherein each response module of the plurality of response modules comprises a plurality of machine learning models for generating a response to the input query; and generating a one or more responses to the first input query using the selected one or more response modules.

In some examples of the first second system, the one or more characteristics of the input query are associated with any one or more of a user, a user segment, or use case.

In some examples of the first second system, the one or more response modules are selected based on a user segment or use case associated with the input query.

In some examples of the first system, the one or more responses to the first input query generated using the selected one or more response modules are tailored to a user segment and a use case.

In some examples of the first system, the plurality of machine learning models in each respective response module comprises each of a foundational language model, one or more adapter models, one or more retrieval models, and a prompting optimization model.

In some examples of the first second system, an adapter model of the one or more adapter models and a retrieval model of the one or more retrieval models are provided upstream of the foundational model to modify an input to the foundational model.

In some examples of the first system, an adapter model of the one or more adapter models and a retrieval model of the one or more retrieval models are provided downstream of the foundational model to modify an output from the foundational model.

In some examples of the first system, the prompting optimization model is configured to modify the first input query using static prompting and dynamic prompting to generate a response generation prompt for the foundational language model.

In some examples of the first second system, an adapter model of the one or more adapter models is configured to modify the response generation prompt generated by the prompting optimization model before the response generation prompt is received by the foundational model.

In some examples of the first system, an adapter model of the one or more adapter models is configured to modify an output of the foundational model, wherein the output of the foundational model is based on the response generation prompt received by the foundational model.

In some examples of the first second system, the first input query is a natural language request to generate a response.

In some examples of the first second system, a generated response of the one or more responses is a natural language response to the first input query.

In some examples of the first system, the one or more metrics associated with each of the one or more response modules are based on one or more interactions of one or more users with one or more previous responses generated by one or more response modules of the plurality of response modules.

In some examples of the first second system, the one or more programs further comprise instructions for: displaying the one or more generated responses to one or more users; and recording one or more interactions of the one or more users with the one or more generated responses.

In some examples of the first system, the one or more programs further comprise instructions for: determining one or more preferred metrics associated with the one or more generated responses based on the one or more recorded interactions with the one or more generated responses.

In some examples of the first system, the one or more programs further comprise instructions for: updating one or more response modules of the selected one or more response modules, based on the preferred metrics, by updating one or more trained machine learning models of the response modules.

In some examples of the first system, the one or more programs further comprise instructions for: receiving a second input query; determining one or more characteristics of the second input query; respectively generating, by each of the one or more updated response modules, one or more respective responses to the second input query based on the characteristics of the second input query.

In some examples of the first second system, the one or more programs further comprise instructions for: selecting, based on the preferred metrics, one or more different response modules from the plurality of response modules.

In some examples of the first system, the one or more programs further comprise instructions for: receiving a second input query; determining one or more characteristics of the second input query; and constructing, based on the preferred metrics and the one or more characteristics of the second input query, one or more response modules for generating a response to the second input query.

In some examples of the first system, a response of the one or more generated responses comprises any one or more of a natural language request for a second input query, a description of a person, a description of a product, a description of a location, and a description of an event.

A first non-transitory computer readable storage medium stores one or more programs, the one or more programs comprising instructions, which when executed by one or more processors of an electronic device, cause the electronic device to: receive a first input query; determine one or more characteristics of the input query; select, from a plurality of response modules, one or more response modules based on the one or more characteristics of the input query, wherein each response module of the plurality of response modules comprises a plurality of machine learning models for generating a response to the input query; and generate a one or more responses to the first input query using the selected one or more response modules.

In some examples of the first non-transitory computer readable storage medium, the one or more characteristics of the input query are associated with any one or more of a user, a user segment, or use case.

In some examples of the first non-transitory computer readable storage medium, the one or more response modules are selected based on a user segment or use case associated with the input query.

In some examples of the first non-transitory computer readable storage medium, the one or more responses to the first input query generated using the selected one or more response modules are tailored to a user segment and a use case.

In some examples of the first non-transitory computer readable storage medium, the plurality of machine learning models in each respective response module comprises each of a foundational language model, one or more adapter models, one or more retrieval models, and a prompting optimization model.

In some examples of the first non-transitory computer readable storage medium, an adapter model of the one or more adapter models and a retrieval model of the one or more retrieval models are provided upstream of the foundational model to modify an input to the foundational model.

In some examples of the first non-transitory computer readable storage medium, an adapter model of the one or more adapter models and a retrieval model of the one or more retrieval models are provided downstream of the foundational model to modify an output from the foundational model.

In some examples of the first non-transitory computer readable storage medium, the prompting optimization model is configured to modify the first input query using static prompting and dynamic prompting to generate a response generation prompt for the foundational language model.

In some examples of the first non-transitory computer readable storage medium, an adapter model of the one or more adapter models is configured to modify the response generation prompt generated by the prompting optimization model before the response generation prompt is received by the foundational model.

In some examples of the first non-transitory computer readable storage medium, an adapter model of the one or more adapter models is configured to modify an output of the foundational model, wherein the output of the foundational model is based on the response generation prompt received by the foundational model.

In some examples of the first non-transitory computer readable storage medium, the first input query is a natural language request to generate a response.

In some examples of the first non-transitory computer readable storage medium, a generated response of the one or more responses is a natural language response to the first input query.

In some examples of the first non-transitory computer readable storage medium, the one or more metrics associated with each of the one or more response modules are based on one or more interactions of one or more users with one or more previous responses generated by one or more response modules of the plurality of response modules.

In some examples of the first non-transitory computer readable storage medium, the one or more programs further comprise instructions, which when executed by one or more processors of an electronic device, cause the electronic device to display the one or more generated responses to one or more users; and recording one or more interactions of the one or more users with the one or more generated responses.

In some examples of the first non-transitory computer readable storage medium, the one or more programs further comprise instructions, which when executed by one or more processors of an electronic device, cause the electronic device to: determine one or more preferred metrics associated with the one or more generated responses based on the one or more recorded interactions with the one or more generated responses.

In some examples of the first non-transitory computer readable storage medium, the one or more programs further comprise instructions, which when executed by one or more processors of an electronic device, cause the electronic device to: update one or more response modules of the selected one or more response modules, based on the preferred metrics, by updating one or more trained machine learning models of the response modules.

In some examples of the first non-transitory computer readable storage medium, the one or more programs further comprise instructions, which when executed by one or more processors of an electronic device, cause the electronic device to: receive a second input query; determine one or more characteristics of the second input query; respectively generate, by each of the one or more updated response modules, one or more respective responses to the second input query based on the characteristics of the second input query.

In some examples of the first non-transitory computer readable storage medium, the one or more programs further comprise instructions, which when executed by one or more processors of an electronic device, cause the electronic device to: select, based on the preferred metrics, one or more different response modules from the plurality of response modules.

In some examples of the first non-transitory computer readable storage medium, the one or more programs further comprise instructions, which when executed by one or more processors of an electronic device, cause the electronic device to: receive a second input query; determine one or more characteristics of the second input query; and construct, based on the preferred metrics and the one or more characteristics of the second input query, one or more response modules for generating a response to the second input query.

In some examples of the first non-transitory computer readable storage medium, a response of the one or more generated responses comprises any one or more of a natural language request for a second input query, a description of a person, a description of a product, a description of a location, and a description of an event.

A second exemplary method is provided for generating a response to an input query, the second exemplary method comprising: receiving a first input query; determining one or more of characteristics of the input query; constructing a response module based on the one or more characteristics of the first input query, wherein constructing a response module comprises selecting a subset of trained machine learning models from a plurality of trained machine learning models to form part of the response module; and generating a response to the first input query using the constructed response module.

A second exemplary system for generating a response to an input query comprises: one or more processors; a memory; and one or more programs, wherein the one or more programs are stored in the memory and configured to be executed by the one or more processors, the one or more programs including instructions for: receiving a first input query; determining one or more of characteristics of the input query; constructing a response module based on the one or more characteristics of the first input query, wherein constructing a response module comprises selecting a subset of trained machine learning models from a plurality of trained machine learning models to form part of the response module; and generating a response to the first input query using the constructed response module.

A second non-transitory computer readable storage medium stores one or more programs, the one or more programs comprising instructions, which when executed by one or more processors of an electronic device, cause the electronic device to: receive a first input query; determine one or more of characteristics of the input query; construct a response module based on the one or more characteristics of the first input query, wherein constructing a response module comprises selecting a subset of trained machine learning models from a plurality of trained machine learning models to form part of the response module; and generate a response to the first input query using the constructed response module.

In some embodiments, any one or more of the features, characteristics, or aspects of any one or more of the above systems, methods, or non-transitory computer-readable storage media may be combined, in whole or in part, with one another and/or with any one or more of the features, characteristics, or aspects (in whole or in part) of any other embodiment or disclosure herein.

### BRIEF DESCRIPTION OF THE FIGURES

FIG. 1A illustrates an exemplary method for generating one or more responses to an input query.

FIG. 1B illustrates an exemplary method for updating one or more response modules and using the updated response modules to generate one or more responses to an input query.

FIG. 1C illustrates an exemplary method for selecting or constructing one or more different response modules and using the one or more different response modules to generate one or more responses to an input query.

FIG. 2 illustrates an exemplary response module in accordance with some embodiments.

FIG. 3 illustrates an exemplary input query and corresponding determination of various characteristics of the input query for response module selection in accordance with some embodiments.

FIG. 4 illustrates an exemplary input query and corresponding generated response in accordance with some embodiments.

FIG. 5 illustrates an exemplary input query and corresponding generated response in accordance with some embodiments.

FIG. 6 illustrates an exemplary configuration for content optimization in accordance with some embodiments.

FIG. 7 illustrates an exemplary architectural diagram depicting the flow from user input to generated response performance metric collection.

FIG. 8 illustrates an exemplary experimentation engine in accordance with some embodiments.

FIG. 9 illustrates an exemplary method for testing one or more response modules using an experimentation engine.

FIG. 10 depicts an exemplary computing device in accordance with some embodiments.

### DETAILED DESCRIPTION

Disclosed herein are exemplary devices, apparatuses, systems, methods, and non-transitory storage media for generating responses to input queries using response modules comprising a plurality of machine learning models, prompting, and configuration files.

First, the following disclosure provides a description of a method for receiving a user input query, determining characteristics of the input query, selecting or constructing one or more response modules for generating one or more responses to the input query, displaying the generated response to the one or more users, and recording user interactions with the generated responses. The input query may be a natural language input by a user through a user interface. The one or more characteristics of the input query may be associated with any one or more of a user, a user segment, or use case, and may include a prompt and a user identifier, and the user identifier may further be associated with user data on a user profile.

The one or more response modules may be selected or constructed based on the input query characteristics, including the prompt, user/user identifier, data associated with the user/user identifier, and user preference metrics associated with the response modules. The selected or constructed one or more modules may be used to generate one or more responses to the input query using, in addition to other module components, a plurality of machine learning models. The generated responses may be displayed to a user through a user interface, for instance, on a user device such as a cell phone, laptop, computer, and so on. Finally, the interactions may include any user interaction with the generated response, such as adding or deleting material from the generated response or transmitting the response to an external application.

The interactions may be used to determine user preference metrics. For instance, a user's interaction with a generated response may indicate a user preference for longer responses. As such, future response modules selected or constructed for the user may include response models best suited for generating long responses to input queries.

Second, the following disclosure describes exemplary methods for using user preference metrics associated with the recorded interactions with the generated responses to update response modules or select or construct new response modules to generate responses to subsequent input queries. The methods for updating response modules include determining preferred metrics associated with response modules based on recorded interactions with the generated responses and updating the response modules based on the preferred metrics to process later input queries. Updating a response module can include any change to a component/aspect of a response module. For instance, updating a response module may comprise changing a configuration file, changing prompting in a prompt database, or finetuning a machine learning model within a module.

The methods for selecting or constructing new response modules may similarly include determining preferred metrics associated with response modules based on recorded interactions with the generated responses, but instead of updating response modules, these methods describe selecting new response modules from a module store/database for processing later input queries or constructing new response modules using one or more different machine learning models, for instance models stored in the module store/database. New modules may be selected or constructed based on preferred metrics and characteristics of the subsequent input queries.

Third, this disclosure describes an exemplary response module used for generating a response to an input query. The exemplary response module comprises a generative language model, a prompting optimization model, retrieval models, adapter models, and a prompt store/database (not shown). The prompting optimization model may be configured to modify a user input using static prompting from the prompt store/database or dynamic prompting from a memory table or streaming application programming interface (API). The retrieval models may be configured to retrieve dynamic prompting from a memory table comprising user data and/or an API. The adapter models may be configured to tailor responses to specific use cases or user segments which the base generative language model is not configured or trained to handle.

Fourth, this disclosure describes several exemplary input queries and corresponding generated responses. Fifth, this disclosure describes an exemplary configuration for content optimization. The description of the configuration for content optimization provides an example of how the systems and methods described herein may test a plurality of response modules against user segments/use cases to determine optimal module metrics for that user segment/use case.

Sixth, this disclosure describes an exemplary system architecture diagram depicting the flow from user input to generated response performance metric collection. The exemplary system architecture diagram illustrates a variety of system components in communication with one another that are used to process input queries and generate responses. The components include a module optimizer for selecting or constructing optimal modules for a given input query, an inference engine for causing a response module to generate a response to a respective input query, a learning engine for recording interactions with generated responses and storing metrics associated with the interactions in a metrics store, an experimentation engine for testing modules against user segments/use cases, a metric store for storing user preference metrics associated with the various response modules, a module store for storing modules, and response modules for generating responses to input queries.

Seventh, this disclosure describes an exemplary experimentation engine and method for carrying out experiments to test response modules in accordance with some embodiments. The experimentation engine may be used to test response modules against various user segments or for various use cases. It leverages customer feedback signals for generative models which allows for segmentation based on learned use cases.

Eighth, the disclosure provides a descriptions of various exemplary response modules including a localization module, an advertising module, and a summarizing module. As noted below, these exemplary response module descriptions are meant to be illustrative and should not be construed as limiting. Ninth, this disclosure provides descriptions of various additional exemplary input queries and responses that may be generated by the response modules disclosed herein.

Tenth, this disclosure provides a description of an exemplary computing device in accordance with the systems and methods described herein.

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed items. It is further to be understood that the terms “includes, “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown but are accorded the scope consistent with the claims.

### Exemplary Method for Generating Responses to Input Queries Using Response Modules

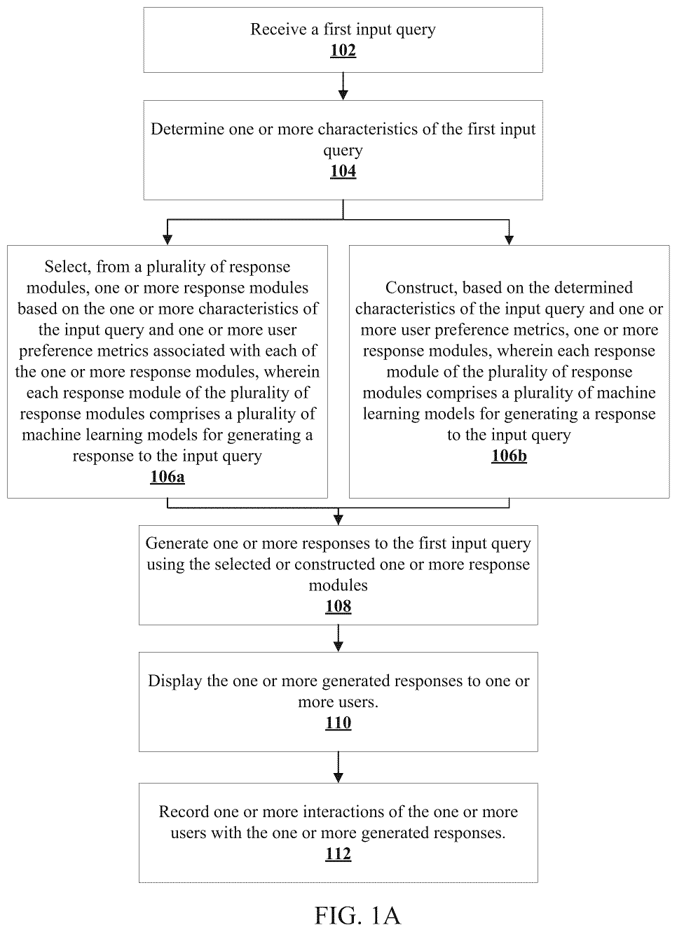

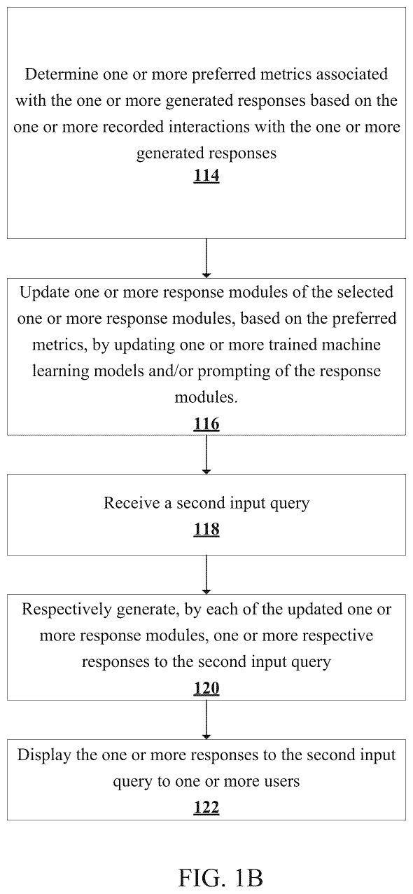

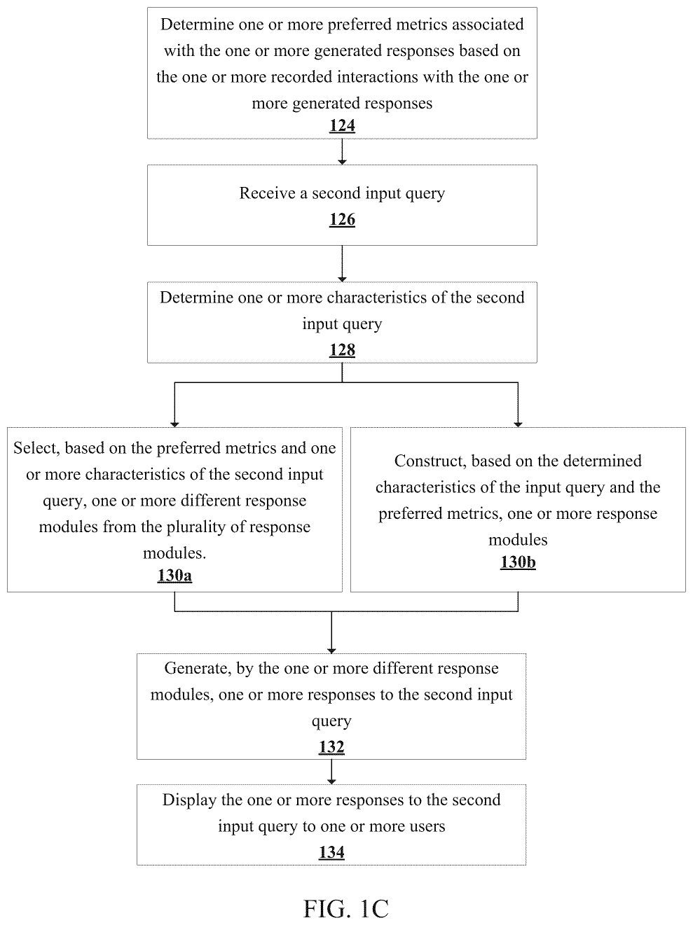

FIG. 1A illustrates an exemplary method 100 for generating one or more responses to an input query. The following description of the method 100 includes a detailed description of the following steps: receiving an input query, determining characteristics of the input query, selecting response modules for generating responses to the input query, generating responses to the input query, displaying the responses, and recording interactions with the generated responses.

The method 100 is performed, for example, using one or more electronic devices implementing a software platform. In method 100, some blocks are, optionally, combined, the order of some blocks is, optionally, changed, and some blocks are, optionally, omitted. In some examples, additional steps may be performed in combination with the method 100. Accordingly, the operations as illustrated (and described in greater detail below) are exemplary by nature and, as such, should not be viewed as limiting.

In some examples, method 100 can begin at step 102, wherein step 102 comprises receiving a first input query. The first input query may be a natural language input query. The first input query may be a request to generate a natural language response to the input query (e.g., “update the product descriptions on my website”).

In some examples, after receiving a first input query at step 102, the method 100 can proceed to step 104, wherein step 104 comprises determining one or more of characteristics of the input query. The one or more characteristics of the input query may be associated with a user, user segment, and/or use case. The one or more characteristics of the input query may include, for instance, a user identifier and a user prompt. The user identifier may be a username, a hash value associated with a specific user, or some other user identifier identifying the user associated with the input query. The user identifier may further be associated with a user profile or database comprising user data associated with the user identifier. A user associated with the user identifier may be an individual or legal entity. The user data may comprise any one or more of: a user age; a user sex; a user gender; a user location; a user occupation; a user industry; a user target audience; a user product; one or more previous input queries input by the user; and one or more previous responses to the input queries input by the user. The user prompt may comprise an indication a desired use case (e.g., “write a blog post,” “update my product descriptions,” etc.).

In some examples, after determining one or more characteristics of the input query at step 104, the method 100 may proceed to step 106a, wherein step 106a comprises selecting, from a plurality of response modules, one or more response modules based on the one or more characteristics of the input query and one or more user preference metrics associated with each of the one or more response modules. Each response module of the plurality of response modules may comprise a plurality of machine learning models for generating a response to the input query. The one or more user preference metrics associated with each of the one or more response modules may be based on one or more interactions of one or more users with one or more previous responses generated by each of the one or more response modules. The plurality of response modules may be stored in a database.

In some examples, selecting, from a plurality of response modules, one or more response modules based on the one or more characteristics of the input query and one or more metrics associated with each of the one or more response modules comprises: determining a relationship between an input query characteristic (e.g., user prompt or user identifier) and user data associated with the input query characteristic. Upon determining the relationship, a system performing the method 100 may select one or more response modules may by comparing the user data associated with the input query characteristic with one or more metrics associated with each of the plurality of response modules, and selecting, based on the comparison, one or more response modules from the plurality of response modules.

For instance, the user data may comprise a target audience. An input query may be received from a user that states “write an advertisement to sell my shoes to my customers.” User data associated with the user's customers (i.e., the target audience for the advertisement) may indicate that the user's customers are, for example, women in large cities of the United States. The identified target audience may be compared with metrics associated with the plurality of response modules, wherein the metrics may represent the preferences of similar target audiences. For example, metrics associated with the plurality of response modules may indicate that a respective response module performed well when writing advertisements for fashion accessories for women in the United States, and as such, that module may be selected to generate a response to the input query.

The above-described process for selecting, from a plurality of response modules, one or more response modules based on the one or more characteristics of the input query and one or more metrics associated with each of the one or more response modules may be based on a variety of different user data. For instance, in some examples, the user data comprises a user age, a user gender, a user location, a user occupation, or a user industry. It should be understood that the aforementioned list is not meant to be limiting.

In some examples, selecting, from a plurality of response modules, one or more response modules based on the one or more characteristics of the input query and one or more metrics associated with each of the one or more response modules includes consideration of characteristics of the user who input the input query, characteristics of historical requests from the user or other users, characteristics of the current input query, and other factors including a random effect. A module with metrics indicating a high probability of success given the aforementioned characteristics and other factors may be selected to generate a response to the input query.

In some examples, the one or more response modules may be selected based on a user segment and use case associated with the input query. For instance, a user segment may comprise bankers and a use case may comprise commodities trading research articles. For such a combination of user segment and use case, a module with metrics associated with strong fact preservation and data retrieval capabilities may be selected to retrieve data associated with, for instance, the commodities which a respective user typically covers, and data associated with the respective commodities. Other user segments and use cases may require modules with metrics associated with additional or different capabilities, for instance, creativity (e.g., hallucination by a generative language model as opposed factual information retrieved by a retrieval model) may be a desired feature for a user segment of fiction writers.

In some examples, after determining one or more characteristics of the input query at step 104, the method 100 may proceed to step 106b, wherein step 106b comprises constructing, based on the determined characteristics of the input query and one or more user preference metrics, one or more response modules. Each response module of the plurality of response modules may comprise a plurality of machine learning models for generating a response to the input query. Constructing the response module may comprise selecting a foundational model and one or more secondary models for generating a response to the input query. As described above, the foundational model may be a generative language model and the secondary models may include retrieval models, adapter models, and a prompting optimization model.

In some examples, each response module comprises a plurality of machine learning models, wherein the plurality of machine learning models includes a foundational/base model and one or more secondary models. The foundational/base model may be a generative language model and the one or more secondary models may be retrieval models, adapter models, and a prompting optimization model. Each response module may comprise more than one foundational model, but if more than one foundational model is required, then more commonly, a second module comprising a second respective foundational module would be selected or constructed to process the input query and generate a response as needed. In other words, each response module will typically comprise a single foundational model.

In some examples, each of the plurality of response modules comprises a database of static prompting. The static prompting may be used by the prompting optimization model to modify the input query to form at least part of a modified input query/generated prompt for the foundational model or adapter model upstream of the foundational model. The modified first input query may comprise one or more different words from the first input query. The prompting optimization model may modify an input query (e.g., generate a prompt for the foundational model or adapter model upstream of the foundational model using a language-to-language task) to improve various prompts based on characteristics of the user that provided the input query. For instance, an input query may request a description of the zoo. However, the user may be known to be an animal rights activist based on user specific data associated with the user. So, a prompting optimization model may be used to insert prompting into the input query that will generate outputs based on that user characteristic (i.e., based on the fact that the user is an animal rights activist). For example, the input query received from a user may recite “write a blog post about the zoo” and the prompting optimization model may generate a prompt using the input query that recites “write a blog post about the zoo from the point of view of an animal rights activist discussing the ethical issues associated with keeping animals in captivity.”

In some examples, a retrieval model of the one or more retrieval models is configured to retrieve information from one or both of a memory table and a streaming API. The memory table may comprise data associated with a plurality of users. The data associated with a plurality of users in the memory table may comprise data associated with a first user and data associated with a second user. The data associated with the first user may be partitioned from the data associated with the second user within the memory table. The information retrieved from one or both of a memory table and a streaming API may be combined with the first input query to form at least part of a modified input query, wherein the modified input query may be configured to be received by the foundational model or an adapter model upstream of the foundational model.

In some examples, an adapter model of the one or more adapter models is configured to modify an output of the foundational model, wherein the output of the foundational model is based on the modified input query received by the foundational model. For instance, an adapter model may be used to tailor a response to a respective user, user segment, and/or use case by “filling gaps” based on what a user wants and what a foundational model is capable of. The adapter model may be used to inject various different “tones” or “styles” to a generated response to the input query.

In some examples, the plurality of machine learning models includes one or more finetuned adapter models, one or more finetuned retrieval models, and one or more finetuned language models. For instance, the models may be finetuned for finding relevant data from a database (e.g., if user said “summarize trips I took last year” the retrieval model could search the database, retrieve info on “trips taken,” and either pass the information on as prompting or prepare the information for prompting (e.g. send snippets of the information)). If the user said “rewrite this product description for customers who leave the best reviews for us on Website A” the retrieval model may retrieve and abstract a customer profile based on Website A review scores in the database, and then feed it as prompting to the next stage in a format the next model could be instructed on. It should be understood that finding relevant data from a database is only one of many different tasks the models within a response module may be finetuned for.

In some examples, each model forming a response module further comprises configurations/configuration files for optimizing one or more parameters, settings, preferences, etc. of each respective machine learning model of the plurality of machine learning models. Changing various aspects of the configurations files to optimize more parameters, settings, preferences, etc. of each respective machine learning model may impact quality, length, etc. of the outputs of the respective models.

In some examples, after selecting, from a plurality of response modules, one or more response modules based on the one or more characteristics of the input query and one or more metrics associated with each of the one or more response modules at step 106a, or constructing based on the determined characteristics of the input query, one or more response modules at step 106b, the method 100 may proceed to step 108, wherein step 108 comprises generating one or more responses to the first input query using the selected one or more response modules.

As described above with regard to response module selection and/or construction the one or more responses to the first input query generated using the selected or constructed response modules may be tailored to a user segment, for instance, by using prompting optimized for that user segment, adapter models finetuned for generating outputs for that user segment, and so on. Accordingly, an exemplary input query received from a user may recite “write a blog post about health concerns for hockey players.” User data associated with the user providing the input query may indicate that the user is a prosthodontist specializing in restoring broken or missing teeth resulting from hockey related injuries. As such, the generated response may be tailored (e.g., using a response module comprising models best fit for such a user or user segment) to focus on the treatment of injuries resulting in broken or missing teeth sometimes suffered due to the inherent risks of the sport. As an additional example, a product description for ice cream may be generated for two different user segments as follows. For firefighters, the generated description may recite “beat the fire with some ice” and for schoolchildren, the generated description may recite “enjoy a fun summer treat.”

Additionally, as described with regard to response module selection and/or construction, the one or more responses to the first input query generated using the selected or constructed response modules may be tailored to a use case, for instance, by using prompting optimized for that use case, adapter models finetuned for generating outputs for that use case, and so on. For instance, an input query may request generation of product descriptions. As such, a retrieval model would be required that can understand user profiles and retrieve data about the respective users and the user's relevant products. Thus, a response module comprising such a retrieval model (and any other necessary models) would be selected or constructed accordingly. As another example, a long musical screenplay use case module would heavily lean towards generating creative long form outputs. It would not optimize for factuality. In contrast, product description response generations would lean more on fact retrieval and fact preservation, possibly with a second adapter for injecting creativity into the response.

In some examples, generating one or more responses to the first input query using the selected or constructed one or more response modules comprises using a combination of the aforementioned foundational model and one or more secondary models (e.g., foundational language model, adapter models, retrieval models, and prompting optimization models) provided in a respective response module to generate one or more responses to the first input query.

In some examples, the input query may be processed by a plurality of models forming the response model to generate a response in the following order. The first model activated within a module in response to receiving an input query may be a retrieval model, which retrieves data for insertion, along with the input query, into a prompting optimization model. The data may be retrieved from a memory table/database and/or an API. For instance, if the input query states “update my product descriptions” then the retrieval model may retrieve the current product descriptions from the user's website API, E-Commerce API, etc. and user data from the memory table/database.

In some examples, the second model activated/called within the module may be a prompting optimization model, which is a trained generative model configured to generate prompting based on the input query, data retrieved by a retrieval model upstream of the prompting optimization model, and/or static prompting previously generated by the prompting optimization model. For instance, the prompting optimization model may generate, based on the input query “update my product descriptions” and data retrieved by the retrieval model, prompting that recites, in part, “For each of the following product descriptions, create ten separate product description outputs that are each fit to be empathetic with a target audience of Firefighters from Chicago; however, keep the fitting abstractive and nonliteral and only weigh the audience twenty percent.”

In some examples, the third model activated/called within the module may be the foundational model (a large generative language model for generating a response to the prompting generated by the prompting optimization model based on the input query). The foundational model may generate, for instance, ten updated product descriptions in accordance with the prompting generated above by the prompting optimization model. It should be understood that the generative model may generate any number of responses to any number of input queries, and the example set forth herein for generating product descriptions is not meant to be limiting.

In some examples, the fourth model called is an adapter model, which may be activated/called downstream of the foundational model to adapt the response generated by the foundational model to a specific user segment/use case. The adapter model is a generative model trained for specific tasks which the foundational model may not be capable of handling. For instance, an adapter model may receive the generated output of the foundational model and generate a response based on the foundational model output which is written in a certain tone or style (for instance, a lighter or more serious tone), or a response translated into a different language, and so on.

While the exemplary response module provided above is described with reference to various models processing an input query and generating a response in a specified order, the sequence of models within a respective response module can be modified without deviating from the scope of the claims. For instance, retrieval and adapter models may be called before and after the prompting optimization model, before and after the foundational model, and so on. As such, response modules may employ a variety of models in a variety of sequences depending on the circumstances, for instance depending on a respective user segment or use case associated with the input query, to generate a response to an input query.

As described above, the foundational model may be a large language model. The foundational model may be tasked with performing content generation. The secondary models (e.g., adapter models, retrieval models, prompting optimization models, etc.) may be tasked with preprocessing the input before receipt by the foundational model and/or postprocessing the output of the foundational model. One or more of the secondary models may be tasked with data retrieval, last mile adaptations, fact checking, and so on for tailoring a generated response to a specific input query, user or user segment, use case, and so on. In some examples, an input query may be routed through various models and/or processing stages within a selected or constructed response module for generating a response to the input query.

In some examples, a plurality of responses are generated in response to a single input query. In some examples, a first response of the plurality of responses to the first input query comprises one or more features different from one or more features of a second response of the plurality of responses to the first input query. For instance, a response generated by a first module of the one or more modules may be longer, more semantically complex, more creative, etc., than an output of a second module of the one or more response modules. The features of the generated responses may vary based on the plurality of trained machine learning models included in each of the one or more modules. Interactions with the first and second response may be associated with metrics used to identify user/audience preferences with regard to the varying features of the responses. Any number of features may be tested, for instance, response length, semantic complexity, relevance, humor, factuality, creativity level, and so on.

The variation in response features may be useful for automatically determining preferences across various user segments and/or use cases. As such, for each use case (e.g., blogging, news articles, advertisements, etc.) and for each user segment (students, professors, businesses, engineers, comedians, food bloggers, etc.) experiments may be carried out to determine optimal end-use metrics, which are then used to select or construct the best modules for the respective user segments and use cases. As an example, responses varying by length may be generated for a user segment of college professors. Based on interactions by the users in the user segment, it may be determined that college professors prefer longer responses on average than other user segments. As such, modules best suited for generating longer responses may be selected in the future for users within that respective user segment.

The variation in response features may also be useful for users in determining the preferences of their own audiences. The variation in response length may be useful, for instance, for gauging a target audience's preferred length. For example, if a user is a blogger that wants to know the preferred length of a blog post for their average reader, a plurality of responses may be generated at varying length in order to determine such preferences among their audience based on interactions with the blog posts of different lengths.

In some examples, after generating the one or more responses to the first input query using the selected one or more response modules at step 108, the method 100 may proceed to step 110, wherein step 110 comprises displaying the one or more generated responses to one or more users. The response may be displayed on a user interface. The user interface may be the same user interface through which the first input query was received or the user interface may be a different user interface than the user interface through which the first input query was received. The response may be displayed on a user device, such as a personal computer, laptop, mobile phone, television, or tablet.

In some examples, after displaying the one or more generated responses to one or more users at step 110, the method 100 may proceed to step 112, wherein step 112 comprises recording one or more interactions of the one or more users with one or more generated responses. An interaction of the one or more interactions may be a positive interaction (e.g., liking a response, sharing a response, etc.) or a negative interaction (deleting a response or portion of a response, disliking a response, etc.). A positive interaction may increase the likelihood of the response module being selected for future input queries by the same user and/or users within the same user segment or for future input queries associated with the same or similar use cases. A negative interaction may decrease the likelihood of the response module being selected for future input queries by the same user and/or users within the same user segment or for future input queries associated with the same or similar use cases. An interaction of the one or more interactions may comprise changing, by a user, a response of the one or more generated responses. Changing, by a user, a response of the one or more generated responses may comprise deleting a portion of the response or adding additional information (e.g., additional text) to the response.

In some examples, an interaction of the one or more interactions comprises transmitting a response of the one or more generated responses to an external application. In some examples, an interaction of the one or more interactions comprises copying a response of the one or more generated responses and pasting the response in an external application. The external application may be a social media platform, blog, website, text editor, messaging application, or any other application configured to receive user inputs or data. In some examples, an interaction of the one or more interactions is an engagement with a social medial post, wherein the social media post is based on the generated response (e.g., the social media post is created by transmitting the generated response to the social media platform or copying and pasting the generated response into a post on the respective social media platform).

An engagement with a social media post may comprise any one or more of: likes, comments, shares, views, pictogram or other symbolic reactions, dislikes, upvotes, downvotes, or any other engagement mechanism provided by a social media platform. It should be understood that the list of engagements with social media posts is exemplary and not meant to be limiting. The respective engagements on the external platform may be recorded and used to determine one or more preferred metrics associated with the respective response.

### Exemplary Method for Updating Response Modules and Using the Updated Response Modules to Generate Responses to Input Queries

FIG. 1B illustrates a continuation of the exemplary method 100. The description of the continuation of method 100 depicted in FIG. 1B provided below comprises a detailed description of the following steps: determining preferred metrics based on recorded interactions with the responses, updating one or more response modules based on the preferred metrics, receiving a second input query, generating responses to the second input query using the updated response modules, and displaying the generated responses.

In some examples, after recording one or more interactions of the one or more users at step 112, the method 100 may proceed to step 114, wherein step 114 comprises determining one or more preferred metrics associated with the one or more generated responses based on the one or more recorded interactions with the one or more generated responses.

In some examples, a metric of the one or more metrics is associated with response length, semantic complexity, relevance, humor, context preservation, context rhetoric difference, humor, creativity level, factual preservation, grammatical correctness, semantic similarity, sentiment (positive, negative, etc.), intent (sell, inform, persuade, etc.), contradiction, entailment, sentence quality, topic coherence, whether the response answers the question/input query, two sentence meaning, user engagement, user copy rate, document inclusion rate, instruction following, style instruction adherence, style relevance, intent relevance, diversity/variation, latency, safety, toxicity, etc. For instance, a response generated by a first module of the one or more modules may be longer than a response generated by a second module of the one or more modules. The length of the generated responses may vary based on the first and second modules comprising different foundational language models, different secondary models including different retrieval models, adapter models, prompting optimization models, different static prompting, different dynamic prompting, different configurations, and/or different finetuning.

In some examples, after determining one or more preferred metrics associated with the one or more generated responses based on the one or more recorded interactions with the one or more generated responses at step 114, the method 100 may proceed to step 116, wherein step 116 comprises updating one or more response modules of the selected one or more response modules, based on the preferred metrics, by updating one or more trained machine learning models (e.g., retrieval models, adapter models, prompting optimization models, or the foundational language model), for instance, by finetuning a model of the one or more machine learning models, training a model with few-shot learning techniques, or updating configuration files associated with the models. In other words, if it is possible to obtain a desired result by making a less cost intensive update (e.g., updating prompting in a prompting database or updating a configuration file associated with a model rather than finetuning or retraining a machine learning model within a module) then the less cost intensive update will be made.

In some examples, after updating one or more response modules of the selected or constructed one or more response modules at step 116, the method 100 may proceed to step 118, wherein step 118 comprises receiving a second input query. The second input query may be a second natural language input query. The second input query may be a request to generate a natural language response to the input query. The second input query may be different from or the same as the first input query.

In some examples, after receiving a second input query at step 118, the method 100 may proceed to step 120, wherein step 120 comprises respectively generating, by each of the updated one or more response modules, one or more respective responses to the second input query. In some examples, after generating, by the updated response modules, one or more responses to the second input query at step 120, the method 100 may proceed to step 122, wherein step 122 comprises displaying the one or more responses to the second input query to one or more users.

In some examples, the one or more responses to the second input query are different from the one or more responses to the first input query. The one or more responses to the second input query may be different from the one or more responses to the first input query regardless of whether the second input query is the same as or different from the first input query. The one or more responses to the second input query may comprise a request for a third input query. After displaying the one or more responses to the second input query to one or more users at step 122, the process of determining one or more preferred metrics based on interactions with the responses may be iteratively repeated.

### Exemplary Method for Selecting or Constructing Different Response Modules and Using the Different Response Modules to Generate Responses to Input Queries

FIG. 1C illustrates an exemplary method continuation of the method 100 for selecting and/or constructing one or more different response modules and using the one or more different response modules to generate one or more responses to an input query.

In some examples, after recording one or more interactions of the one or more users with the one or more generated responses at step 112, the method 100 may proceed to step 124, wherein step 124 comprises determining one or more preferred metrics associated with the one or more generated responses based on the one or more recorded interactions with the one or more generated responses.

In some examples, a metric of the one or more metrics is associated with response length, semantic complexity, relevance, humor, context preservation, context rhetoric difference, humor, creativity level, factual preservation, grammatical correctness, semantic similarity, sentiment (positive, negative, etc.), intent (sell, inform, persuade, etc.), contradiction, entailment, sentence quality, topic coherence, whether the response answers the question/input query, two sentence meaning, user engagement, user copy rate, document inclusion rate, instruction following, style instruction adherence, style relevance, intent relevance, diversity/variation, latency, safety, toxicity, etc. For instance, a response generated by a first response module of the one or more response modules may be longer than a response generated by a second module of the one or more modules. The length of the generated responses may vary based on the first and second modules comprising different foundational language models, different secondary models including different retrieval models, adapter models, prompting optimization models, different static prompting, different dynamic prompting, different configurations, different finetuning, and so on.

In some examples, after determining one or more preferred metrics associated with the one or more generated responses based on the one or more recorded interactions with the one or more generated responses at step 124, the method 100 may proceed to step 126, wherein step 126 comprises receiving a second input query. The second input query may comprise a natural language input query. The second input query may be the same as or different from the first input query. The second input query may be a request to generate a natural language response to the input query.

In some examples, after receiving a second input query at step 126, the method 100 may proceed to step 128, wherein step 128 comprises determining one or more characteristics of the second input query. The determined characteristics may be similar to any one or more of the characteristics described above with regard to the first input query.

After determining one or more characteristics of the second input query at step 128, the method 100 may proceed to step 130a, wherein step 130a comprises selecting, based on the preferred metrics and one or more characteristics of the second input query, one or more different response modules from the plurality of response modules. The one or more different response modules may be selected from a plurality of response modules stored in a database. Alternatively or additionally, after determining one or more characteristics of the second input query at step 128, the method 100 may proceed to step 130b, wherein step 130b comprises constructing based on the determined characteristics of the input query and the preferred metrics, one or more response modules. In some examples, the one or more different response modules selected or constructed at steps 130a and 130b, respectively, comprise one or more different machine learning modules, different static prompting, different configuration files, or any other variety of different components of a response module, as described throughout, from the one or more response modules selected and/or constructed at steps 106a and 106b, respectively.

In some examples, after selecting, based on the preferred metrics and one or more characteristics of the second input query, one or more different response modules from the plurality of response modules at step 130a, and/or constructing based on the determined characteristics of the input query and the preferred metrics, one or more response modules at step 130b, the method 100 may proceed to step 132, wherein step 132 comprises generating, by the one or more different response modules, one or more responses to the second input query. In some examples, after generating, by the one or more different response modules, one or more responses to the second input query at step 132, the method 100 may proceed to step 134, wherein step 134 comprises displaying the one or more responses to the second input query. In some examples, the process described above for generating responses, recording interactions with the responses, and updating/selecting new modules based on the recorded interactions is an iterative process.

### Exemplary Response Module

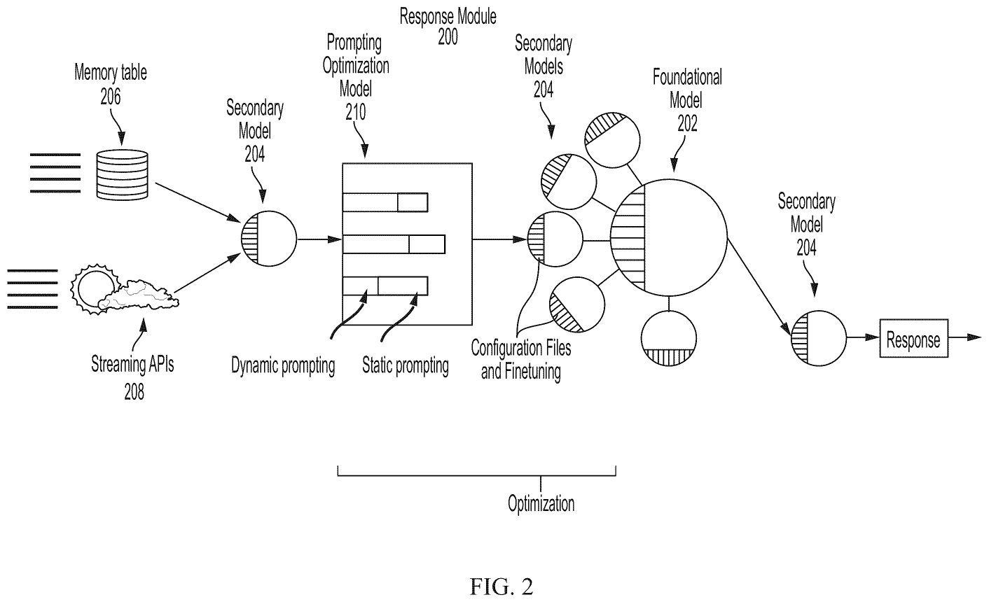

FIG. 2 illustrates an exemplary response module for generating a response to an input query, in accordance with some embodiments. It should be understood that the processing stages within the module depicted in FIG. 2 are sequence agnostic, meaning that one or more of the processing stages may be performed in a different order than depicted in the figure, one or more of the processing stages may be omitted, and one or more additional or different processing stages may be included without deviating from the scope of the claims set forth herein.

As depicted in FIG. 2, a response module 200 may comprise a foundational model 202, a plurality of secondary models 204 (retrieval and adapter models), and a prompting optimization model/prompting model 210. Each of the respective models may be associated with various configuration files and may be finetuned for specific tasks (e.g., retrieval or generative tasks). The response module 200 may be configured to communicate (e.g., using a retrieval model of the one or more secondary models 204) with one or more memory tables 206 and one or more streaming APIs 208.

As noted above, response modules are sequence agnostic. Meaning that a response to an input query may be generated by calling the plurality of models in a given response module in a variety of orders. A common sequence of models within a response module may substantially align with the following description. The first model called may be a retrieval model of the one or more secondary models 204. The retrieval model may retrieve information based on the input query from a memory table/database and/or an API. For instance, if an input query recited “write an article about restaurants in Washington, DC,” the retrieval model may retrieve information related to restaurants in Washington, DC from one or both of the memory table/database (e.g., previous responses generated on this topic for the same user) and an API (e.g., information associated with specific restaurants in Washington, DC from the API).

The second model called may be the prompting optimization model/prompting model 210. The information retrieved by the retrieval model may be used by the prompting optimization model/prompting model to modify the input query in order to generate a prompt better suited for a downstream generative model (e.g., the foundational model or an adapter model). The prompting optimization model/prompting model may also modify the respective input query may be using static prompting from a prompt store (i.e., a database of predefined/static prompts) again, to generate a prompt better suited for a downstream generative model.

The third model called may be the foundational model 202 (e.g. a large pretrained generative language model). The foundational model may receive the prompt generated by the prompting model/prompting optimization model 210, and generate a response to the input query based on the prompt.

The fourth model called may be an adapter model of the one or more secondary models 204. The adapter model of the one or more secondary models 204 may receive the response generated by the foundational model 210 and further adapt the response (e.g., to a specific use case/user segment) before the final response is displayed to the user.

As noted above, one or more secondary models provided subsequent to the foundational model may be tasked with performing substantially the same retrieval and/or adaptation tasks as the one or more secondary models provided prior to the foundational model. As such one or more secondary models provided subsequent to the foundational model may retrieve additional information to be included in a generated response and/or adapt a response to conform to a specific user's tone, style, etc. prior to outputting the response to a user. For instance, downstream retrieval models may pull citations or hyperlinks from a database to augment the generated output from a language model, and upstream adapter models may receive input queries and/or information retrieved by a retrieval model as inputs and generate an input prompt for a downstream generative model (e.g., the prompting model or foundational model).

### Exemplary Input Queries and Generated Responses

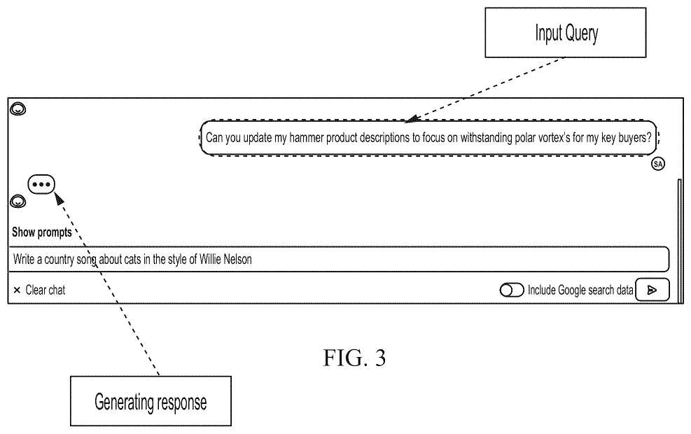

FIG. 3, illustrates an exemplary input query and corresponding determination of various characteristics of the input query. As shown, the exemplary input query received in FIG. 3 is “Can you update my hammer product descriptions to focus on withstanding polar vortex's for my key buyers?” The input query here may be used to automatically determine (e.g., using a language model) a target audience (Firefighters in Chicago), a channel/use case (Product Descriptions), and memories (e.g., data from a memory table/database related to hammers and user tone). As such, the target audience may be the audience whom the user plans to direct the generated output to, the use case may be the channel/output medium for which a response is being generated (e.g., a product description webpage, a social media post for a specific social media platform, a blog post, etc.), and memories may comprise user data including previous input queries and generated responses associated with the user as well as user data associated with various other user preferences like response tone. Various data associated with the target audience, channel, and memories may be loaded from a database and used as dynamic prompting in generating a response to the input query.

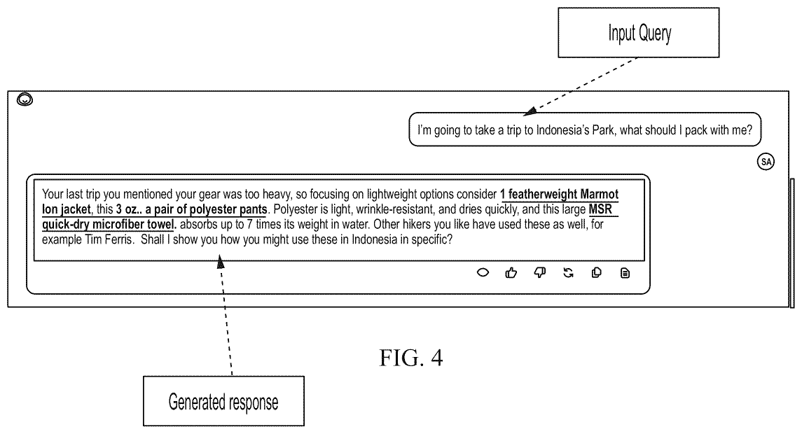

FIG. 4 illustrates an exemplary input query and corresponding generated response. In FIG. 4, the input query recites “I'm going to take a trip to Indonesia's Park, what should I pack with me?” displayed on a user interface. Based on the input query, a system as described herein for generating responses to input queries using response modules may be determine that the respective user is asking for recommendations. In response, a recommendation engine may be evoked, wherein the recommendation engine may be a module comprising a retrieval model that retrieves user data and data from various E-commerce APIs. The retrieval model may retrieve data from the various E-commerce APIs based on known preferences associated with the user. For instance, if the user prefers hiking more than swimming, the retrieval model may retrieve recommendations for a new pair of hiking boots. The data retrieved by the recommendation engine may then be used to prompt the generative model (foundational model or adapter model, or both) within the module to generate a response to the input query, which provides various recommendations for items the user should pack for their trip to Indonesia park, as shown in FIG. 4.

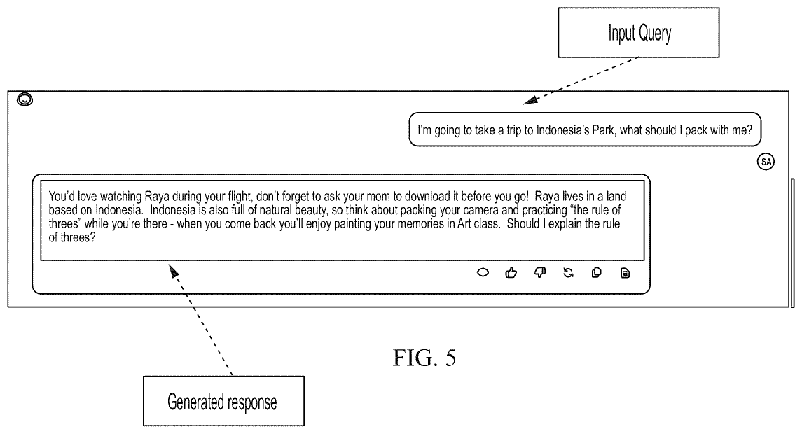

FIG. 5 illustrates an exemplary generated response to the same input as FIG. 4, “I'm going to take a trip to Indonesia's Park, what should I pack with me?”, wherein the same input is received from a different user. As shown, the two different users may receive a different response. In FIG. 5, one or more characteristics of the input query indicate that the user is 9 years old, enjoys animated movies, and is accessing the interface using an education application. Based on the above characteristics of the input query, a module for generating safe content for minors and that does not allow for retrieval/generation of specific advertising or sales content is selected or constructed. The module contains a retrieval model that retrieves data only from a database of educational material. As such, data from the database of educational material is used to prompt the generative model in the module to generate the response shown in FIG. 5. As such, in combination FIGS. 4 and 5 illustrate how two users inputting the same input query may receive different responses based on user data associated with the respective users.

### Exemplary Experimental Response Module Selection and Response Generation

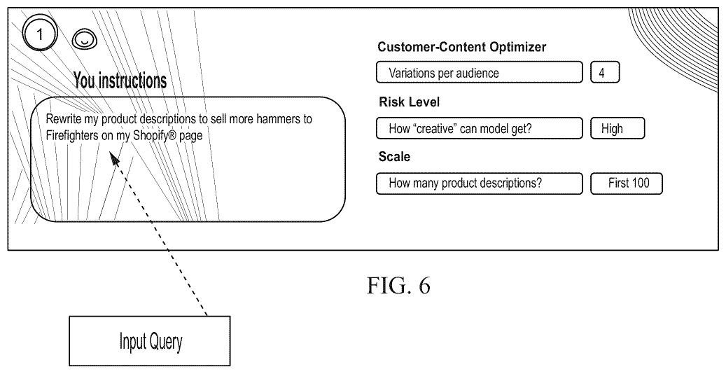

FIG. 6 provides an illustrative example of generating a plurality of responses using four response modules, recording interactions with the responses generated by the response modules, and optimizing responses based on the recorded interactions. As shown, the input query may recite “rewrite my product descriptions to sell more hammers to Firefighters. . . . ” The characteristics of the input query may indicate that the user inputting the input query wants to discover what sort of content their customers prefer, and four response modules may be selected or constructed (for instance, by the experimentation engine described below) that will test metrics for the responses generated by each of the four response modules.

The four response modules may initially be selected or constructed based upon user specific data associated with the respective user including an identified target audience (Firefighters in Chicago), a channel (Product Descriptions), and one or more memories (a memory associated with the user's Hammers and a memory associated with the user's preferred Tone). If no modules known to perform well with firefighters in Chicago exist in the module store, then modules known to be preferred by similar audiences (e.g., police officers) may be selected or constructed. The experimentation engine may determine one or more additional response metrics to test based on the input query, for instance, risk level (e.g., how “creative” the models in the module should be) and a response scale (e.g., how many product descriptions should be included in a response to the input query “rewrite my product descriptions to sell more hammers to Firefighters on my Shopify page”).

Interactions with the generated responses by the four selected modules will be used to determine which metrics correspond to more positive interactions (for instance, “likes” either recorded through a user interface on which the generated response is displayed or through an external application, such as a social media platform, to which the generated response is transmitted). Based on the determination of which metrics correspond to more positive interactions, response modules will automatically be optimized through iterative testing, for instance, by updating aspects of the response modules including static prompting, dynamic prompting, configuration files, finetuning models, and/or otherwise updating the machine learning modules provided in the respective response modules, training new machine learning models, selecting one or more different response modules better suited to the preferred metrics, or constructing new response modules, and thus the responses generated by the respective response modules will also be optimized.

In some examples, in response to receiving the above input query “rewrite my product descriptions to sell more hammers to Firefighters . . . ,” a single response module may be used to generate responses for a plurality of user segments/target audiences (e.g., using the prompting model to tailor the input to the generative models to best suit each respective user segment). In some examples, all response modules may be tested against all user segments/target audiences.

### Exemplary System Architecture for Receiving Input Queries and Generating Responses Using Response Modules

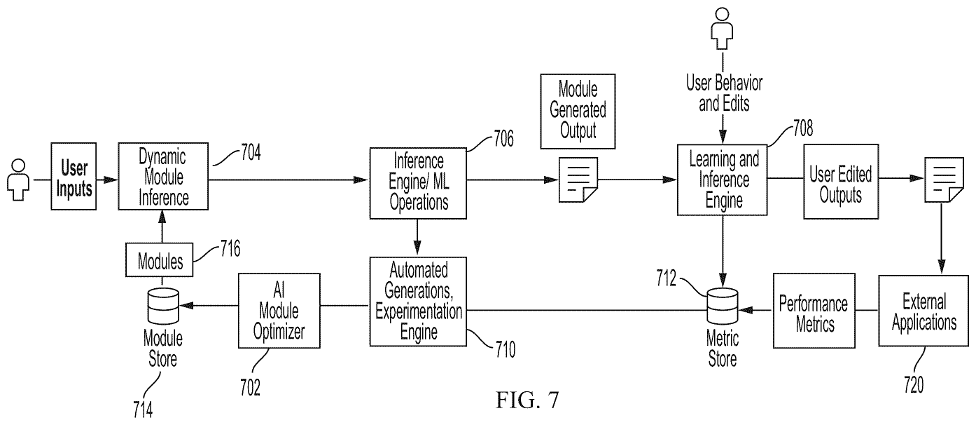

FIG. 7 illustrates an exemplary system 700 for receiving input queries, generating responses to the input queries, and evaluating the responses. The illustration provided in FIG. 7 depicts the flow from user input to metric collection for generated responses. The exemplary system depicted in FIG. 7 is represented as a series of nodes and edges representing the flow of various inputs, processes, components, and generated outputs associated with the architecture for generating a response to an input query.

As shown, the exemplary system depicted in FIG. 7 includes a module optimizer 702, dynamic module inference node 704, an inference engine 706, a learning and inference engine 708, an automated generations experimentation engine 710, a metric store/database 712, a module store/database 714, and response modules 716. These system components may all be interconnected with one another and in communication with an application (not shown) comprising a user interface, and in communication with external applications 720. Each of these components is described in further detail below in this section.

In some examples, the module optimizer 702 may be configured to select or construct a response module for processing the input query received at the dynamic module inference node 704. The module may be selected from a set of preconfigured modules stored in the module store/database 714 or constructed using models stored in the module store/database 714. The response modules may comprise a foundational model (large generative language model) and one or more secondary models (prompting model/prompting optimization model, adapter models, retrieval models).

Each module may contain a variety of different adapter models all finetuned for various different tasks. For instance, a module configured for video transcript summarization may comprise a retrieval model finetuned for retrieving information comprising transcripts or parts of transcripts. The retrieved information may be fed to the foundational model which summarizes the information. Then, a first finetuned adapter model may extract action points (e.g., descriptions of action items or future tasks to be completed based on the transcripts) from the summary output by the foundational model, and a second finetuned adapter may convert the summary into speaker profiles corresponding to each speaker. A third adapter model may be finetuned for translation and may translate the summary/speaker profiles from a first language to a second language.

In some examples, the response module selection and/or construction is based on characteristics of the input query, including the respective user, data associated with the user (e.g., data stored on the user's profile within the application, historical inputs may by the user and other users, the current input query, and other factors including a random effect), and user preference metrics stored in the metric store 710. The selection may be based on any or all of the factors considered in selecting one or more response modules discussed above with respect to FIGS. 1 through 6, including a comparison of the metrics associated with various response modules and the characteristics of the input query. As such module selection and/or construction may be optimized for a respective user segment and/or use case based upon the characteristics of the input query.

As noted above, the response module selected by the module optimizer 702 may be selected from the module store 714. The module store 714 may be a database for storing all existing modules within the system 700. In some examples, a response module selected by the module optimizer comprises everything required to generate specific content (i.e., a response) for a user, including machine learning models, specific trained model weights, user level segmentation groups, use-case classes, prompting optimization models, and any one or more of the module components discussed above with respect to FIGS. 1 through 6.

Compared to typical artificial intelligence natural language generation systems, the exemplary system here dramatically increases the search space available through use of response modules when compared to other existing systems and methods, which are often limited by a mono-model configurations (e.g., generative artificial intelligence systems comprising a single large language model for generating responses to user inputs). Mono-model configurations can be expensive and cumbersome to retrain/adapt to new use cases or users. In contrast, in the systems and methods described herein, response modules allow for granular adjustments to various components of response modules from changing prompting and configuration files to finetuning models within the modules, and so on, such that response modules can be tailored down to specific user preferences. As such, two users having otherwise similar characteristics using the same fine-tuned models can experience different outputs that fit their respective desired levels of semantic complexity or tone.

In some examples, the inference engine 706 may cause the response module 716 selected or constructed by the module optimizer to process the input query to generate a response. The inference engine may allow for inferencing and observes typical machine learning operations functions, including model quality output drift, interpretation of cause, and potential intelligence for the experimentation platform to use to gather demands for the model optimizer. For instance, the inference engine may determine whether are users accepting less content, and if so, the automated generations experimentation engine 708, discussed further below, will determine whether this is because the fact base is stale, because users have new demands, or any number of other potential causes.

In some examples, generating the response may be done in accordance with any methods for generating a response set forth above with reference to FIGS. 1 through 6. For instance, generating one or more responses to the first input query using the selected or constructed response module may comprise using a combination of a foundational model and one or more secondary models (e.g., a foundational language model, secondary adapter models, retrieval models, prompting optimization models, etc., as discussed throughout), fine-tuned variations of the aforementioned models, static prompting, and dynamic prompting to generate one or more responses to the input query.

In some examples, an input query may be routed through various models and/or processing stages within a selected module for generating a response to the input query. For instance, in some examples, an input query may be routed through a selected module as illustrated in FIG. 2, as discussed above.

In some examples, the learning and inference engine 708 is configured to record interactions of users with the generated response output by the inference engine. The learning engine 708 may be in communication with a user interface of the application (not shown), which allows users to interact with the generated response. Users may add to, subtract from, or otherwise modify a generated response. Users may also “like,” or “dislike” a generated response. Users may delete a response, save the response to a database associated with their user profile, or interact with the response in any other number of ways. The learning and inference engine 708 may be configured to record interactions and determine user preferred metrics in accordance with the manner described above with respect to FIGS. 1 through 6.

In some examples, the generated responses, which are optionally modified by the user through the user interface in communication with the learning and inference engine 708, are further transmitted to one or more external applications 720 (e.g., social media platforms, text editors, spreadsheets, etc.), and additional interactions can be recorded with the responses transmitted to the external applications. In some examples, the interactions with the generated responses are used to determine a plurality of user preference metrics associated with the responses. In some examples, the metrics are stored in the metrics store 712.

In some examples, the automated generations experimentation engine 710 may use advanced segmentation, machine learning, and module performance measurement techniques to design and deploy minimal experiments that might have the largest module value. In some examples, the experimentation engine may deploy a plurality of response modules to each generate a respective response to an input query, record user interactions associated with each of the responses, and based on the recorded interactions, determine user preference metrics associated with the response modules. The metrics associated with the response modules may be stored in the metrics store 712 and later may be used to select and/or construct the optimal module for similar user segments and/or use cases. The experimentation engine may deploy a variety of experimentation methods (a/b testing, time series discontinuities) and statistical methods. The resulting metrics may be useful for module selection across user segments/use cases. For instance, the results of one experiment may provide a baseline understanding/starting point for experiments targeting a similar user segment/use case.

Thus, for each use case and/or customer segment, the automated generations experimentation engine 710 seeks to find the optimal end-use metrics score (e.g. associated with response relevance, semantic complexity, length, humor, factuality, etc.), which the model optimizer then uses to find or construct the best response modules. All improvements based on experimentation engine test results are made at the minimal levels required to obtain the desired benefit. For instance, if user preferences indicate a desire for response modules with higher associated humor metrics scores, then new models will not be finetuned if an adjustment to configuration files or prompts can yield the same benefit. Thus, the systems and methods disclosed herein are adaptable at low cost and high efficiency.

### Exemplary Experimentation Engine for Testing Response Modules

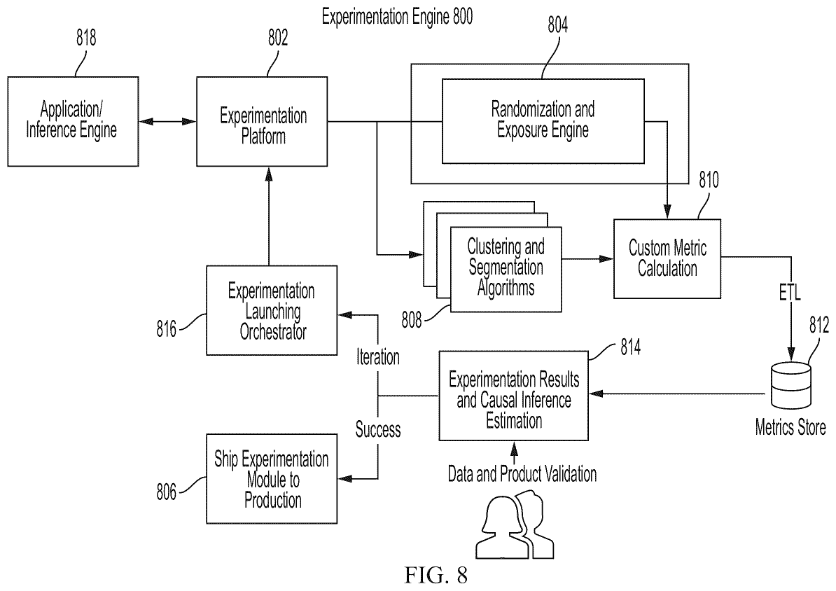

FIG. 8 illustrates an exemplary experimentation engine 800 in accordance with some embodiments. As described above, in some examples, the experimentation engine tests the outputs/responses generated by various modules with users, learns their preferences, and then communicates user preferences to the module optimizer through metrics associated with the response modules. The module optimizer will then select, configure, and finetune the optimal module for a respective user's needs based on results of the testing conducted by the experimentation engine.

As shown in FIG. 8, the experimentation engine 800 includes an Experimentation Platform 802 in communication with each of a Randomization and Exposure Engine 804, an Experimentation Launching Orchestrator 816, Clustering and Segmentation algorithms 808, a Custom Metric Calculation node 810, a Metric Store 812, and an Experimentation Results and Causal Inference Estimation node 814. Each of the experimentation engine components listed above is described in further detail immediately below.

The Experimentation Platform 802 may communicate directly with the Inference Engine 818 and make decisions (e.g., response module selections) that supersede the response module selections made by the response module optimizer (e.g., the response module optimizer discussed above with reference to FIG. 7).

The Randomization and Exposure Engine 804 may perform randomization on the selected module, overriding the response module and inserting another different response module, to test a predetermined hypothesis defined in the Experimentation Launching Orchestrator. This can be a direct interventional A/B experiment (test Response Module A vs Response Module B on a similar sample population, for instance similar user segments), bandit experimentation of multiple response modules, or any other statistical intervention strategy. The Experimentation Launching Orchestrator 816 validates that all experiments are valid. It defines what the experiment is, what aspect of the module will be adjusted, what metrics apply to it, what direction things must move, statistical significance, and unit of randomization. All experiments are run and maintained on a fixed timeline, defined by what is needed to achieve statistical significance for the given product change.

The Clustering and Segmentation algorithms 808 may be purpose-built inferential models (including language models) that help generate population groups/user segments based on any set of features from the user, request/input query and/or response. This could include geography of request, language, user plan type, size of account, information around past uses (if the user predominately writes marketing copy for company A) or extracted info from the body of the request or response (for instance, whether the input query is a specific request for a blog about crypto, or whether a response focuses on travel itineraries).

The Custom Metric Calculation node 810 may be an auto scheduled job for all the metrics stored in the metric store 812. This custom metric calculation runs on a regular cadence, batching content calls to the Response Module Optimizer, calculating quality metrics defined in advance, and storing the metrics with relevant info about each generation, including every cluster or segmentation from the Clustering and Segmentation Algorithms. Once run, all results are stored in the Metric Store 812.

The Experimentation Results and Causal Inference Estimation node 814 may be the result of a launched intervention. The impact of Module A vs Module B under any set of constraints or assumptions can be validated and measured. Impact estimates are given statistical bounds. Decisions are made and results are vetted and improved by Data and Product Humans-in-the-loop for inference. This knowledge is used to create brand new experiments and product launches that move the product experience forward. Successful experiments are shipped to all users via the Module Store.

In summary, the Experimentation Engine 800 tests new and novel models/response modules, frontend UI, or backend changes providing adaptive optimization to ensure that only a sufficient number of users are exposed to experimental module deployments to gain the desired confidence in a launch, mitigating the possibility of serving sub-optimal user experiences.

The Experimentation Engine 800 understands both the Average Treatment Effects for an entire population, but also granular level heterogenous treatment effects. For instance, each experiment (model change, UI change, etc.) doesn't provide only a single bit (n=1) of information (i.e., Launch A vs B), but provides a learned sense of which modules optimally perform for individual users and use cases (n=1000 s).

The experimentation engine constantly learns and creates customer classes based on geography, language, use case, desired tone, length, complexity, and content domain to automate the heterogeneity of different models (for instance, a first module may perform best with respect to professional tone content intended for use case A, but the same module may perform poorly with respect to generating marketing content for use case B). This leverages customer feedback signals for generative models that allow segmentation based on learned use cases.

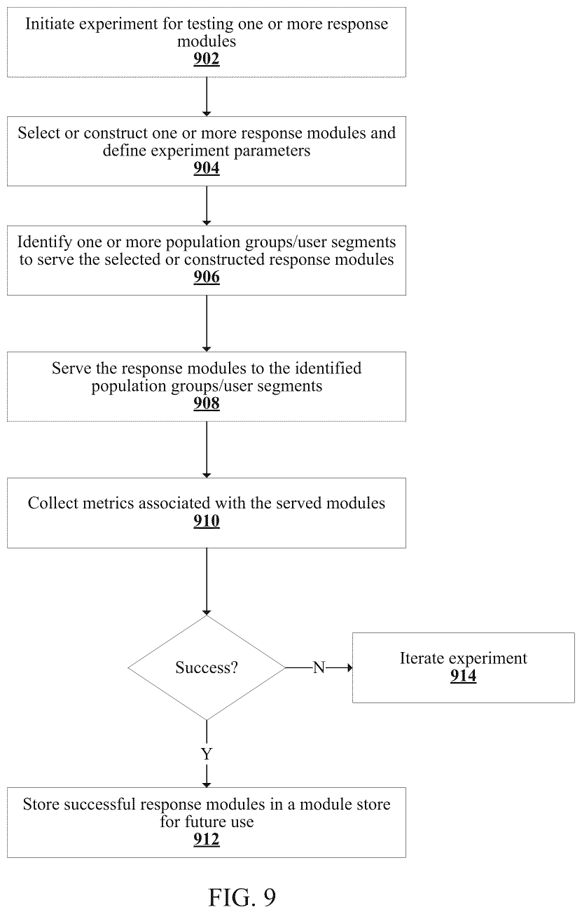

FIG. 9 depicts an exemplary method 900 for testing a response module, for instance, using an experimentation engine as depicted in FIG. 8. The method 900 may begin at step 902, wherein step 902 comprises initiating an experiment for testing one or more response modules. After initiating the experiment at step 902, the method 900 may proceed to step 904, wherein step 904 comprises selecting or constructing one or more response modules and defining experiment parameters (e.g., which model/response module features to test, etc.). After selecting or constructing one or more response modules and defining experiment parameters at step 904, the method 900 may proceed to step 906, wherein step 906 comprises identifying one or more population groups/user segments to serve the selected or constructed response modules.

After identifying one or more population groups/user segments to serve the selected or constructed response modules at step 906, the method may proceed to step 908, wherein step 908 comprises serving the response modules to the identified population groups/user segments. After serving the response modules to the identified population groups/user segments at step 908, the method 900 may proceed to step 910, wherein step 910 comprises collecting metrics associated with the served modules.

After collecting metrics associated with the served response modules at step 910, the method 900 may proceed to step 912, wherein step 912 comprises in accordance with determining that a response module of the served response modules satisfied a success criteria, storing the successful response module in a module store for future use. Alternatively, after collecting metrics associated with the served response modules at step 910, the method 900 may proceed to step 914, wherein step 914 comprises in accordance with determining that a response module of the served response modules failed to satisfy a success criteria, iteratively conducting one or more additional experiments.

### Additional Exemplary Response Modules

Below is a description of various response modules configured for specific content generation tasks. It should be understood that any number of different response modules are possible, and the response modules discussed below are provided only for illustrative purposes and thus not meant to be limiting.

Localization Module: An exemplary response module may be configured for generation of localized articles (e.g., articles tailored for specific audiences in various locations). An input query calling such a module may recite “rewrite my articles related to Topic X for Audience X.” Topic X may be restaurants and Audience Y may be restaurant customers in Japan. A retrieval model may understand that this requires retrieval of the previous versions of the articles, for instance articles about restaurants written for Audience Z, which may be restaurant customers in the United States.

As such, the retrieval model may retrieve, for instance, the previous articles from a memory table/database associated with the user, demographic preferences associated with Audience X from the memory table, and data associated with restaurants in Japan through an API. The information/data retrieved by the retrieval model may be provided to a prompting optimization model as dynamic prompting. The prompting optimization model may then insert static prompting to form a final input prompt for the foundational model.

A foundational model selected for its ability to generate a new article based on a previously written article fit for a different audience (e.g., during response module construction/selection) may receive the input prompt from the prompting model/prompting optimization model and generate the updated articles. Finally, an adapter model selected for its translation capabilities may receive the generated updated articles as an input/inputs and translate the updated articles for Audience X (e.g., into Japanese for Japanese restaurant customers).

Advertising Module: An exemplary response module may be configured for generation of advertisements tailored to specific products or services and targeting various audiences. An input query calling an advertising module may recite “help me sell more of Product A.” Similar to the Localization module described immediately above, a response module comprising trained machine learning models optimized for generating advertisements/product descriptions may be selected or constructed based on the input.

Retrieval models may retrieve data associated with Product A through an API and data associated with user preferences and/or target customer preferences from a memory table/database. The information/data retrieved by the retrieval model may be provided to a prompting optimization model as dynamic prompting, and the prompting optimization model may then insert static prompting to form a final input prompt for the foundational model.

A foundational model selected for its ability to generate advertisements/product descriptions may receive the input prompt from the prompting model/prompting optimization model and generate the advertisements/product descriptions. Finally, an adapter model selected for its translation capabilities may receive the generated advertisements/product descriptions as an input/inputs and adapt the advertisements/product descriptions based on the user and/or target customer preferences.

Summarizing Module: An exemplary response module may be configured for generation of summaries of audio or video recording transcripts. An input query may recite “summarize the transcripts my last videoconference.” Similar to the Localization and Advertising Modules described above, a response module comprising trained machine learning models trained for summarization may be selected or constructed. A retrieval model may retrieve the transcripts from a memory table/database associated with the user and provide the transcripts to a prompting model/prompting optimization model as dynamic prompting. The prompting optimization model may then insert static prompting to form a final input prompt for the foundational model.

The static prompting can, for instance, instruct the foundational model to generate 100, 200, 300, 400, or 500 word summaries of a transcript. It should be understood that the summary lengths indicated above are arbitrary, and the static prompting may instruct the foundational model to generate any variety of summary lengths, or may include any number of other instructions that cause a generative model to generate a summary of an input. For instance, the prompting model may instruct the foundational model to generate a summary of a transcript including a section for completed tasks and a list of future actions (e.g., tasks planned for future completion.).

A foundational model selected for its ability to generate summaries may receive the input prompt from the prompting model/prompting optimization model and generate summaries of the transcripts based on the input. In some examples, the transcript may be automatically broken into manageable segments and each segment of the transcript may be provided to a generative model for summarization.

### Exemplary Generated Responses

A description of a variety of exemplary responses generated by a selected or constructed response module is set forth herein. A response of the one or more generated responses may comprise a request for a second input query. For instance, an input query may recite “can you write me a packing list for my trip to Hawaii?” A response to the input query may recite, in part, “Make sure to pack your bathing suits and sunscreen. Would you like me provide you with a shopping list for the best types of sunscreen and bathing suits for a trip to Hawaii?” In the above example, the generated response includes a request for a second input query, asking the user whether they would like a shopping list for various items the user may wish to pack for their trip to Hawaii.

A response of the one or more generated responses may comprise a description of a person. For instance, an input query may recite “can you write an article about the 42^{nd} President of the United States?” A response to the input query may recite, in part, “Bill Clinton was the 42^{nd} President of the United States.” As noted above, the response may be tailored to a specific use case. For instance, the response may be generated using a style and tone appropriate for a request to “write an article” as opposed to a request to write a blog, a poem, a novel, and so on.

In some examples, a response of the one or more generated responses comprises a description of a product. For instance, an input query requesting an updated product description may recite “can you update my hammer product descriptions to focus on withstanding polar vortexes for my key buyers?” A response to the input query may recite, in part, “Hammers sold by our company are capable of withstanding conditions of extreme cold, so rest assured that our products will not fail you during the next polar vortex.” In some examples, generating a response to a request to generate an updated product description may comprise retrieving data associated with an existing product description stored on a user profile and updating the existing product description.

In some examples, a response of the one or more generated responses comprises a description of a location. For instance, an input query requesting a travel itinerary may recite “I am going to New York City, are there any areas I should visit while there?” A response to the input query may recite, in part, “Times Square is a popular attraction for many tourists visiting New York City.” As noted above, a response may be tailored to the user and recite “Given your interest in the outdoors, you can't miss the chance to take a walk through Central Park during your visit.”

The input query may, in some examples, be a request to generate a travel itinerary for any other specified destination. In some examples, generating the travel itinerary for a specified destination comprises retrieving data from a user profile and data associated with the destination and generating the travel itinerary based on the data from the user profile and data associated with the destination.

In some examples, generating the travel itinerary comprises generating a description of one or more popular locations within a predefined geographical radius of the specified destination. In some examples, generating the travel itinerary comprises generating a description of one or more products available for purchase, wherein the one or more products have previously been purchased by travelers to the specified destination. In some examples, generating the travel itinerary for a specified destination comprises generating a description of one or more transportation methods to the specified destination.

In some examples, a response of the one or more generated responses comprises a description of an event. For instance, an input query may recite “write a blog post about the game.” A response to the input query may include a description of a previous or upcoming sporting event associated with a specific team, if for instance the user requesting the response is a blogger focused on a specific sports team. As noted throughout, whether the blogger in this example is focused on a specific sports team may be determined on user data associated with the user including but not limited to previous input queries from the respective user.

### Exemplary Computing Device

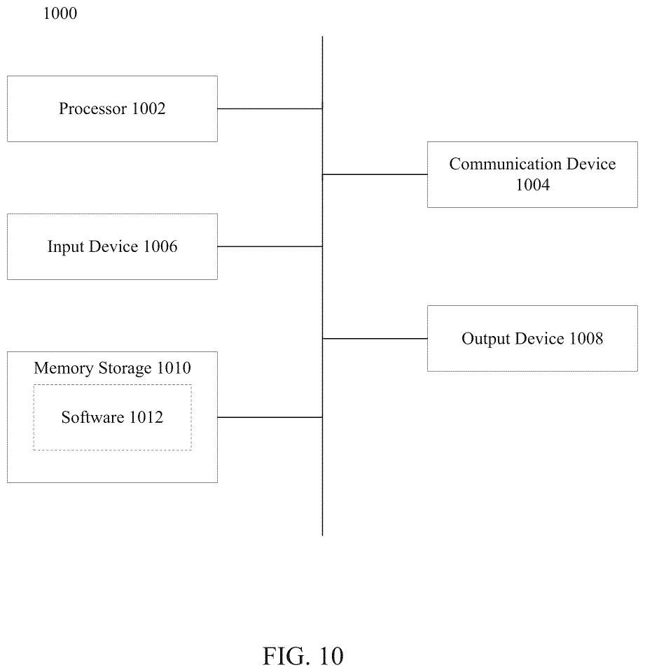

FIG. 10 depicts an exemplary computing device 1000, in accordance with one or more examples of the disclosure. Device 1000 can be a host computer connected to a network. Device 1000 can be a client computer or a server. As shown in FIG. 10, device 1000 can be any suitable type of microprocessor-based device, such as a personal computer, workstation, server, or handheld computing device (portable electronic device) such as a phone or tablet. The device can include, for example, one or more of processors 1002, input device 1006, output device 1008, storage 1010, and communication device 1004. Input device 1006 and output device 1008 can generally correspond to those described above and can either be connectable or integrated with the computer.

Input device 1006 can be any suitable device that provides input, such as a touch screen, keyboard or keypad, mouse, or voice-recognition device. Output device 1008 can be any suitable device that provides output, such as a touch screen, haptics device, or speaker.

Storage 1010 can be any suitable device that provides storage, such as an electrical, magnetic, or optical memory, including a RAM, cache, hard drive, or removable storage disk. Communication device 1004 can include any suitable device capable of transmitting and receiving signals over a network, such as a network interface chip or device. The components of the computer can be connected in any suitable manner, such as via a physical bus or wirelessly.

Software 1012, which can be stored in storage 1010 and executed by processor 1002, can include, for example, the programming that embodies the functionality of the present disclosure (e.g., as embodied in the devices as described above).

Software 1012 can also be stored and/or transported within any non-transitory computer-readable storage medium for use by or in connection with an instruction execution system, apparatus, or device, such as those described above, that can fetch instructions associated with the software from the instruction execution system, apparatus, or device and execute the instructions. In the context of this disclosure, a computer-readable storage medium can be any medium, such as storage 1010, that can contain or store programming for use by or in connection with an instruction execution system, apparatus, or device.

Software 1012 can also be propagated within any transport medium for use by or in connection with an instruction execution system, apparatus, or device, such as those described above, that can fetch instructions associated with the software from the instruction execution system, apparatus, or device and execute the instructions. In the context of this disclosure, a transport medium can be any medium that can communicate, propagate, or transport programming for use by or in connection with an instruction execution system, apparatus, or device. The transport readable medium can include, but is not limited to, an electronic, magnetic, optical, electromagnetic, or infrared wired or wireless propagation medium.

Device 1000 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Device 1000 can implement any operating system suitable for operating on the network. Software 1012 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

Although the disclosure and examples have been fully described with reference to the accompanying figures, it is to be noted that various changes and modifications will become apparent to those skilled in the art. Such changes and modifications are to be understood as being included within the scope of the disclosure and examples as defined by the claims. Finally, the entire disclosure of the patents and publications referred to in this application are hereby incorporated herein by reference.

1. A method for generating a response to an input query, the method comprising:
receiving a first input query;
determining one or more of characteristics of the input query;
selecting, from a plurality of response modules, one or more response modules based on the one or more characteristics of the input query and one or more metrics associated with each of the one or more response modules, wherein each response module of the plurality of response modules comprises a plurality of machine learning models for generating a response to the input query; and
generating one or more responses to the first input query using the selected one or more response modules.

2. The method of claim 1, wherein the one or more characteristics of the input query are associated with any one or more of a user, a user segment, or use case.

3. The method of claim 2, wherein the one or more response modules are selected based on a user segment or use case associated with the input query.

4. The method of claim 1, wherein the one or more responses to the first input query generated using the selected one or more response modules are tailored to a user segment and a use case.

5. The method of claim 1, wherein the plurality of machine learning models in each respective response module comprises each of a foundational language model, one or more adapter models, one or more retrieval models, and a prompting optimization model.

6. The method of claim 5, wherein an adapter model of the one or more adapter models and a retrieval model of the one or more retrieval models are provided upstream of the foundational model to modify an input to the foundational model.

7. The method of claim 5, wherein an adapter model of the one or more adapter models and a retrieval model of the one or more retrieval models are provided downstream of the foundational model to modify an output from the foundational model.

8. The method of claim 5, wherein the prompting optimization model is configured to modify the first input query using static prompting and dynamic prompting to generate a response generation prompt for the foundational language model.

9. The method of claim 8, wherein an adapter model of the one or more adapter models is configured to modify the response generation prompt generated by the prompting optimization model before the response generation prompt is received by the foundational model.

10. The method of claim 5, wherein an adapter model of the one or more adapter models is configured to modify an output of the foundational model, wherein the output of the foundational model is based on the response generation prompt received by the foundational model.

11. The method of claim 1, wherein the first input query is a natural language request to generate a response.

12. The method of claim 1, wherein a generated response of the one or more responses is a natural language response to the first input query.

13. The method of claim 1, wherein the one or more metrics associated with each of the one or more response modules are based on one or more interactions of one or more users with one or more previous responses generated by one or more response modules of the plurality of response modules.

14. The method of claim 1, further comprising displaying the one or more generated responses to one or more users; and recording one or more interactions of the one or more users with the one or more generated responses.

15. The method of claim 14, further comprising: determining one or more preferred metrics associated with the one or more generated responses based on the one or more recorded interactions with the one or more generated responses.

16. The method of claim 15, further comprising: updating one or more response modules of the selected one or more response modules, based on the preferred metrics, by updating one or more trained machine learning models of the response modules.

17. The method of claim 16, further comprising: receiving a second input query; determining one or more characteristics of the second input query; respectively generating, by each of the one or more updated response modules, one or more respective responses to the second input query based on the characteristics of the second input query.

18. The method of claim 15, further comprising: selecting, based on the preferred metrics, one or more different response modules from the plurality of response modules.

19. The method of claim 15, further comprising: receiving a second input query; determining one or more characteristics of the second input query; and constructing, based on the preferred metrics and the one or more characteristics of the second input query, one or more response modules for generating a response to the second input query.

20. The method of claim 1, wherein a response of the one or more generated responses comprises any one or more of a natural language request for a second input query, a description of a person, a description of a product, a description of a location, and a description of an event.

21. A system for generating a response to an input query, comprising:
one or more processors;
a memory; and
one or more programs, wherein the one or more programs are stored in the memory and configured to be executed by the one or more processors, the one or more programs including instructions for:
receiving a first input query;
determining one or more characteristics of the input query;
selecting, from a plurality of response modules, one or more response modules based on the one or more characteristics of the input query, wherein each response module of the plurality of response modules comprises a plurality of machine learning models for generating a response to the input query; and
generating a one or more responses to the first input query using the selected one or more response modules.

22. A non-transitory computer readable storage medium storing one or more programs, the one or more programs comprising instructions, which when executed by one or more processors of an electronic device, cause the electronic device to:
receive a first input query;
determine one or more characteristics of the input query;
select, from a plurality of response modules, one or more response modules based on the one or more characteristics of the input query, wherein each response module of the plurality of response modules comprises a plurality of machine learning models for generating a response to the input query; and
generate a one or more responses to the first input query using the selected one or more response modules.
